(19) United States
(12) Patent Application Publication
(10) Pub. No.: US 2025/0254726 A1
(43) Pub. Date: Aug. 7, 2025

(54) PROCEDURES FOR LOW LATENCY TRAFFIC IN WIRELESS LOCAL AREA NETWORKS

(71) Applicant: Samsung Electronics Co., Ltd., Suwon-si (KR)

(72) Inventors: Peshal Nayak, Plano, TX (US); Boon Loong Ng, Plano, TX (US); Rubayet Shafin, Allen, TX (US); Vishnu Vardhan Ratnam, Frisco, TX (US); Yue Qi, Plano, TX (US); Bilal Sadiq, Plano, TX (US)

(21) Appl. No.: 19/036,819

(22) Filed: Jan. 24, 2025

Related U.S. Application Data
(60) Provisional application No. 63/549,146, filed on Feb. 2, 2024.
(60) Provisional application No. 63/568,311, filed on Mar. 21, 2024.

(51) Int. Cl. H04W 74/0816; H04L 5/00; H04W 72/512; H04W 74/08

(52) U.S. Cl. CPC H04W 74/0816; H04L 5/0053; H04W 72/512; H04W 74/0866

(57) ABSTRACT

An electronic apparatus receives a resource allocation message allocating a dedicated resource for a control message for low latency traffic from an access point. The electronic apparatus transmits an indication message indicating existence of low latency traffic on the dedicated resource to the access point. The electronic apparatus receives a trigger frame eliciting the low latency traffic from the access point, and transmits the low latency traffic to the access point.

### CROSS-REFERENCE TO RELATED APPLICATIONS

This application claims the benefit of priority from U.S. Provisional Application No. 63/549,146 entitled “FREQUENCY MANAGEMENT FOR NEXT GENERATION WLANS,” filed Feb. 2, 2024; and U.S. Provisional Application No. 63/568,311 entitled “LOW LATENCY TRAFFIC HANDLING PROCEDURES WITHIN A TXOP FOR NEXT GENERATION WLANS,” filed Mar. 21, 2024, all which are incorporated herein by reference in their entirety.

### TECHNICAL FIELD

This disclosure relates generally to a wireless communication system, and more particularly to, for example, but not limited to, handling low latency traffic in wireless local area networks.

### BACKGROUND

The ultra-high reliability study group (UHR SG) is the study group for next generation Wi-Fi standards design (IEEE 802.11bn). The UHR SG has set a number of objectives for the next generation Wi-Fi network design. The group intends to achieve the ultra-high reliability target by reducing latencies to ultra-low values, increasing throughputs at different signal-to-noise ratio (SNR) levels, enhancing power savings, etc. To meet these objectives, the group intends to develop new protocols and concepts for performance improvement compared to Wi-Fi 7.

Some of the new applications that the UHR group has considered to provide support for in next generation Wi-Fi networks are shown in Table 1. Table 1 shows example applications with ultra-low latency requirements. Specifically, for each application category, Table 1 shows the requirements in terms of intra basic service set (BSS) latency which is the time to transmit a frame from the access point (AP) to the station (STA) or vice versa, the jitter variance, packet loss and data rate (Mbps).

TABLE 1

| | | Intra BSS | Jitter | | |
|---|---|---|---|---|---|
| | | latency | variance | | |
| Use cases | | (ms) | (ms) | Packet loss | Data rate (Mbps) |
| Real-time gaming | | <5 | <2 | <0.1% | <1 |
| Cloud gaming | | <10 | <2 | Near-lossless | <0.1 (Reverse link) |
| | | | | | >5 Mbps (Forward |
| | | | | | link) |
| Real-time video | | <3~10 | <1~2.5 | Near-lossless | 100~28,000 |
| Robotics | Equipment | <1~10 | <0.2~2 | Near-lossless | <1 |
| and | control | | | | |
| industrial | Human | <1~10 | <0.2~2 | Near-lossless | <1 |
| automation | safety | | | | |
| | Haptic | <1~5 | <0.2~2 | Lossless | <1 |
| | technology | | | | |
| | Drone | <100 | <10 | Lossless | <1 |
| | control | | | | >100 with video |

During channel access, if the channel is occupied by a high throughput transmission with long physical layer (PHY) protocol data unit (PPDU) duration, it may be difficult to support the low latency (LL) traffic in LL stations (STAs), when LL traffic delay tolerance is less than or comparable to the TXOP duration of the high throughput traffic transmission.

FIG. 17 shows a technological problem for handling the law latency traffic.

Referring to FIG. 17, the AP station transmits high throughput traffic to a non-AP station STA1 during 4 msec. During the AP's transmission of the high throughput traffic, LL traffic whose delay tolerance is 3 msec may arrive at a non-AP station STA2. However, the LL traffic should be dropped due to expiration if the AP's transmission of the high throughput traffic is not completed within 3 msec of arrival of the LL traffic.

Furthermore, in order to reduce interference and enhance frequency usage, efficient utilization of secondary channels is important. However, mechanisms to achieve this have not been introduced.

The description set forth in the background section should not be assumed to be prior art merely because it is set forth in the background section. The background section may describe aspects or embodiments of the present disclosure.

### SUMMARY

The present disclosure is directed to improvements in wireless communication. In particular, the present disclosure is directed to reduction of latencies in the wireless communication.

In some embodiments, an electronic apparatus comprises: a memory; and a processor operably coupled to the memory. The processor is configured to cause: receiving a resource allocation message allocating a dedicated resource for a control message for low latency traffic from an access point, transmitting an indication message indicating existence of low latency traffic on the dedicated resource to the access point, receiving a trigger frame eliciting the low latency traffic from the access point, and transmitting the low latency traffic to the access point in response to the trigger frame.

In some embodiments, the indication message is transmitted on the dedicated resource during uplink transmission performed by a station.

In some embodiments, the indication message is transmitted on the dedicated resource simultaneously when an acknowledgement frame is transmitted by a first station.

In some embodiments, another indication message indicating existence of low latency traffic at a second station is transmitted by the second station on another dedicated resource for the second station simultaneously when the acknowledgement frame is transmitted by the first station.

In some embodiments, the indication message is transmitted in a first duration on the dedicated resource during transmission of an uplink physical layer protocol data unit (PPDU) performed by a first station.

In some embodiments, another indication message indicating existence of low latency traffic at a second station is transmitted by the second station in a second time duration on the dedicated resource during transmission of the uplink PPDU performed by the first station, wherein the second duration is not overlapped with the first duration.

In some embodiments, another indication message indicating existence of low latency traffic at a second station is transmitted by the second station on the dedicated resource during transmission of another uplink PPDU performed by the first station.

In some embodiments, a dedicated resource is used within a transmission opportunity (TXOP) for the control message for low latency traffic, the indication message is transmitted within the TXOP to the access point, the trigger frame is received within the TXOP from the access point, and the low latency traffic is transmitted within the TXOP to the access point.

In some embodiments, the dedicated resource does not overlap with a resource for non-low latency traffic in time and frequency.

In some embodiments, the dedicated resource is a group of subcarriers in a data field following a preamble.

In some embodiments, an electronic apparatus comprises: a memory; and a processor operably coupled to the memory. The processor is configured to cause: transmitting a resource allocation message allocating a dedicated resource for a control message for low latency traffic to one or more stations, receiving an indication message indicating existence of low latency traffic on the dedicated resource from a first station, transmitting a trigger frame eliciting the low latency traffic to the first station, and receiving the low latency traffic from the first station in response to the trigger frame.

In some embodiments, the indication message is received from the first station on the dedicated resource during uplink transmission performed by a second station.

In some embodiments, the indication message is received from the first station on the dedicated resource simultaneously when an acknowledgement frame is transmitted by a second station.

In some embodiments, another indication message indicating existence of low latency traffic at a third station is received from the third station on another dedicated resource for the third station simultaneously when the acknowledgement frame is transmitted by the second station.

In some embodiments, the indication message is received from the first station in a first duration on the dedicated resource during transmission of an uplink physical layer protocol data unit (PPDU) performed by a second station.

In some embodiments, another indication message indicating existence of low latency traffic at a third station is transmitted by the third station in a second time duration on the dedicated resource during transmission of the uplink PPDU performed by the second station, wherein the second duration is not overlapped with the first duration.

In some embodiments, another indication message indicating existence of low latency traffic at a third station is transmitted by the third station on the dedicated resource during transmission of another uplink PPDU performed by the second station.

In some embodiments, a dedicated resource is used within a transmission opportunity (TXOP) for the control message for low latency traffic, the indication message is received within the TXOP from the first station, the trigger frame is transmitted within the TXOP to the first station, and the low latency traffic is received within the TXOP from the first station.

In some embodiments, the dedicated resource does not overlap with a resource for non-low latency traffic in time and frequency.

In some embodiments, the dedicated resource is a group of subcarriers in a data field following a preamble.

### BRIEF DESCRIPTION OF THE DRAWINGS

FIG. 1 shows an example of a wireless network in accordance with an embodiment.

FIG. 2 shows an example of an AP in accordance with an embodiment.

FIG. 3 shows an example of a STA in accordance with an embodiment.

FIG. 4 shows low latency traffic handling procedures within a TXOP for WLANS in accordance with an embodiment.

FIG. 5 shows a dedicated frequency resources creation procedure in accordance with an embodiment.

FIG. 6 shows a dedicated time resources creation procedure in accordance with an embodiment.

FIG. 7 shows a dedicated resource unit creation procedure in accordance with an embodiment.

FIG. 8 shows a dedicated resource utilization procedure in accordance with an embodiment.

FIG. 9 shows operations of the AP STA in the transmission state.

FIG. 10 shows operations of the AP STA in the reception state.

FIG. 11 shows a procedure for preemption during downlink transmission of high throughput traffic in accordance with an embodiment.

FIG. 12 shows a procedure for preemption during triggered uplink transmission of high throughput traffic in accordance with an embodiment.

FIG. 13 shows a procedure for handling low latency traffic in accordance with an embodiment.

FIG. 14 shows a frequency management procedure for WLANs in accordance with an embodiment.

FIG. 15 shows a procedure for handling ultra-low latency traffic in accordance with an embodiment.

FIG. 16 shows a procedure for multi-AP (MAP) coordination in accordance with an embodiment.

FIG. 17 shows a technological problem for handling the law latency traffic.

In one or more implementations, not all the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

The detailed description set forth below, in connection with the appended drawings, is intended as a description of various implementations and is not intended to represent the only implementations in which the subject technology may be practiced. Rather, the detailed description includes specific details for the purpose of providing a thorough understanding of the inventive subject matter. As those skilled in the art would realize, the described implementations may be modified in various ways, all without departing from the scope of the present disclosure. Accordingly, the drawings and description are to be regarded as illustrative in nature and not restrictive. Like reference numerals designate like elements.

The following description is directed to certain implementations for the purpose of describing the innovative aspects of this disclosure. However, a person having ordinary skill in the art will readily recognize that the teachings herein can be applied in a multitude of different ways. The examples in this disclosure are based on WLAN communication according to the Institute of Electrical and Electronics Engineers (IEEE) 802.11 standard, including IEEE 802.11be standard and any future amendments to the IEEE 802.11 standard. However, the described embodiments may be implemented in any device, system or network that is capable of transmitting and receiving radio frequency (RF) signals according to the IEEE 802.11 standard, the Bluetooth standard, Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), 5G NR (New Radio), AMPS, or other known signals that are used to communicate within a wireless, cellular or internet of things (IoT) network, such as a system utilizing 3G, 4G, 5G, 6G, or further implementations thereof, technology.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Multi-link operation (MLO) is a key feature that is currently being developed by the standards body for next generation extremely high throughput (EHT) Wi-Fi systems in IEEE 802.11be. The Wi-Fi devices that support MLO are referred to as multi-link devices (MLD). With MLO, it is possible for a non-AP MLD to discover, authenticate, associate, and set up multiple links with an AP MLD. Channel access and frame exchange is possible on each link between the AP MLD and non-AP MLD.

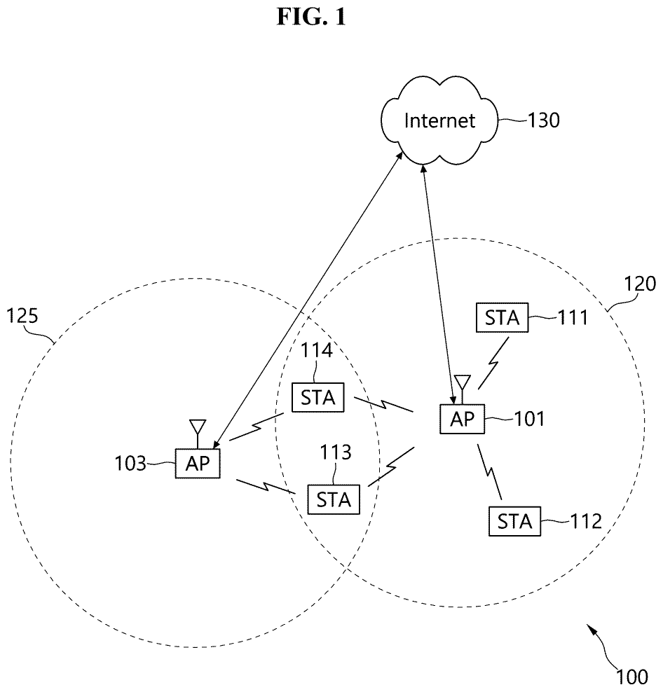

FIG. 1 shows an example of a wireless network 100 in accordance with an embodiment. The embodiment of the wireless network 100 shown in FIG. 1 is for illustrative purposes only. Other embodiments of the wireless network 100 could be used without departing from the scope of this disclosure.

As shown in FIG. 1, the wireless network 100 may include a plurality of wireless communication devices. Each wireless communication device may include one or more stations (STAs). The STA may be a logical entity that is a singly addressable instance of a medium access control (MAC) layer and a physical (PHY) layer interface to the wireless medium. The STA may be classified into an access point (AP) STA and a non-access point (non-AP) STA. The AP STA may be an entity that provides access to the distribution system service via the wireless medium for associated STAs. The non-AP STA may be a STA that is not contained within an AP-STA. For the sake of simplicity of description, an AP STA may be referred to as an AP and a non-AP STA may be referred to as a STA. In the example of FIG. 1, APs 101 and 103 are wireless communication devices, each of which may include one or more AP STAs. In such embodiments, APs 101 and 103 may be AP multi-link device (MLD). Similarly, STAs 111-114 are wireless communication devices, each of which may include one or more non-AP STAs. In such embodiments, STAs 111-114 may be non-AP MLD.

The APs 101 and 103 communicate with at least one network 130, such as the Internet, a proprietary Internet Protocol (IP) network, or other data network. The AP 101 provides wireless access to the network 130 for a plurality of stations (STAs) 111-114 with a coverage are 120 of the AP 101. The APs 101 and 103 may communicate with each other and with the STAs using Wi-Fi or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

In FIG. 1, dotted lines show the approximate extents of the coverage area 120 and 125 of APs 101 and 103, which are shown as approximately circular for the purposes of illustration and explanation. It should be clearly understood that coverage areas associated with APs, such as the coverage areas 120 and 125, may have other shapes, including irregular shapes, depending on the configuration of the APs.

As described in more detail below, one or more of the APs may include circuitry and/or programming for management of MU-MIMO and OFDMA channel sounding in WLANs.

Although FIG. 1 shows one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provides STAs with direct wireless broadband access to the network 130. Further, the APs 101 and/or 103 could provide access to other or additional external networks, such as external telephone networks or other types of data networks.

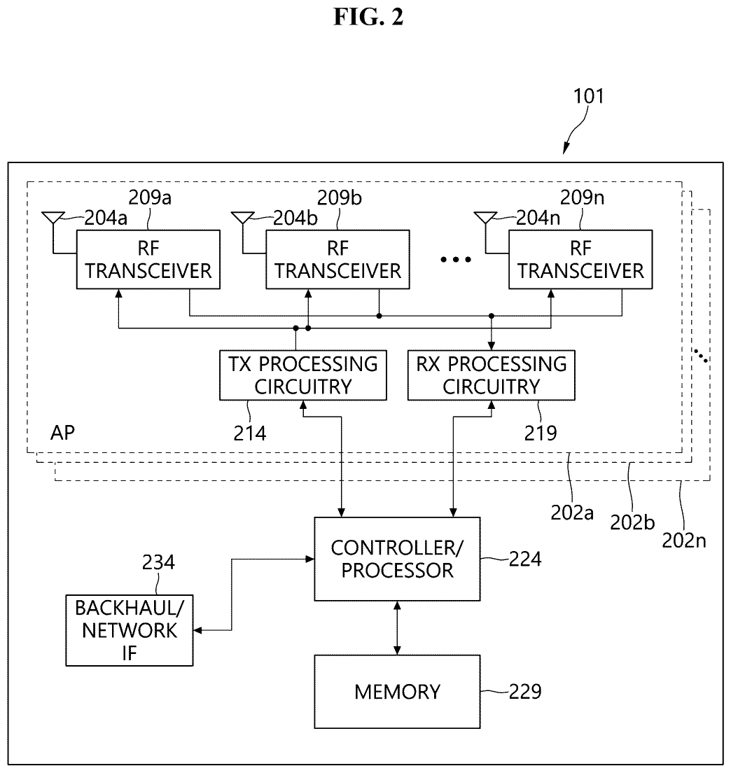

FIG. 2 shows an example of AP 101 in accordance with an embodiment. The embodiment of the AP 101 shown in FIG. 2 is for illustrative purposes, and the AP 103 of FIG. 1 could have the same or similar configuration. However, APs come in a wide range of configurations, and FIG. 2 does not limit the scope of this disclosure to any particular implementation of an AP.

As shown in FIG. 2, the AP 101 may include multiple antennas 204a-204n, multiple radio frequency (RF) transceivers 209a-209n, transmit (TX) processing circuitry 214, and receive (RX) processing circuitry 219. The AP 101 also may include a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate intermediate (IF) or baseband signals. The IF or baseband signals are sent to the RX processing circuitry 219, which generates processed baseband signals by filtering, decoding, and/or digitizing the baseband or IF signals. The RX processing circuitry 219 transmits the processed baseband signals to the controller/processor 224 for further processing.

The TX processing circuitry 214 receives analog or digital data (such as voice data, web data, e-mail, or interactive video game data) from the controller/processor 224. The TX processing circuitry 214 encodes, multiplexes, and/or digitizes the outgoing baseband data to generate processed baseband or IF signals. The RF transceivers 209a-209n receive the outgoing processed baseband or IF signals from the TX processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of uplink signals and the transmission of downlink signals by the RF transceivers 209a-209n, the RX processing circuitry 219, and the TX processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including a combination of DL MU-MIMO and OFDMA in the same transmit opportunity. In some embodiments, the controller/processor 224 may include at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 may include any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for management of channel sounding procedures in WLANs. Although FIG. 2 illustrates one example of AP 101, various changes may be made to FIG. 2. For example, the AP 101 could include any number of each component shown in FIG. 2. As a particular example, an AP could include a number of interfaces 234, and the controller/processor 224 could support routing functions to route data between different network addresses. As another example, while shown as including a single instance of TX processing circuitry 214 and a single instance of RX processing circuitry 219, the AP 101 could include multiple instances of each (such as one per RF transceiver). Alternatively, only one antenna and RF transceiver path may be included, such as in legacy APs. Also, various components in FIG. 2 could be combined, further subdivided, or omitted and additional components could be added according to particular needs.

As shown in FIG. 2, in some embodiment, the AP 101 may be an AP MLD that includes multiple APs 202a-202n. Each AP 202a-202n is affiliated with the AP MLD 101 and includes multiple antennas 204a-204n, multiple radio frequency (RF) transceivers 209a-209n, transmit (TX) processing circuitry 214, and receive (RX) processing circuitry 219. Each APs 202a-202n may independently communicate with the controller/processor 224 and other components of the AP MLD 101. FIG. 2 shows that each AP 202a-202n has separate multiple antennas, but each AP 202a-202n can share multiple antennas 204a-204n without needing separate multiple antennas. Each AP 202a-202n may represent a physical (PHY) layer and a lower media access control (MAC) layer.

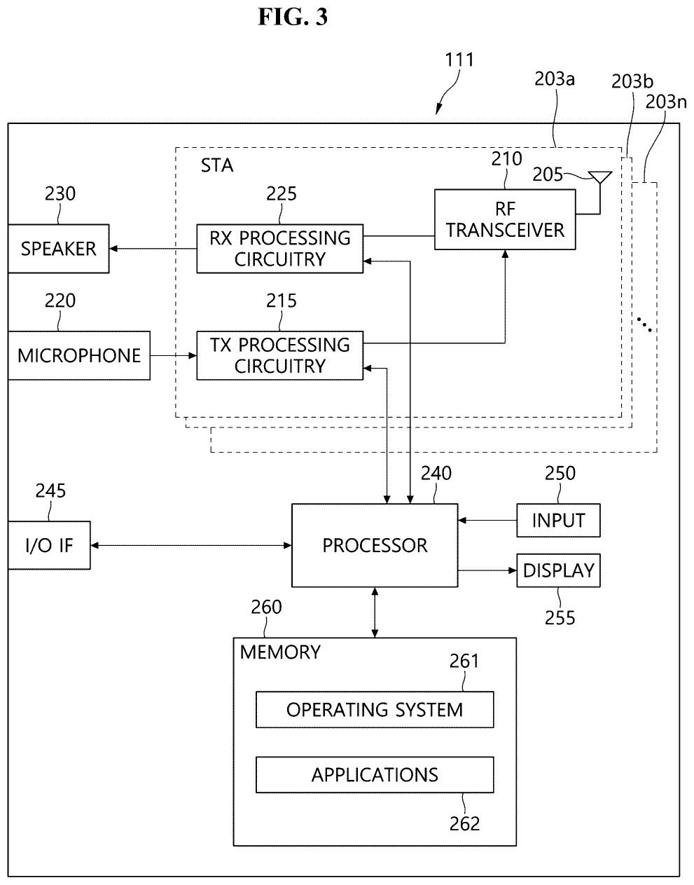

FIG. 3 shows an example of STA 111 in accordance with an embodiment. The embodiment of the STA 111 shown in FIG. 3 is for illustrative purposes, and the STAs 111-114 of FIG. 1 could have the same or similar configuration. However, STAs come in a wide variety of configurations, and FIG. 3 does not limit the scope of this disclosure to any particular implementation of a STA.

As shown in FIG. 3, the STA 111 may include antenna(s) 205, a RF transceiver 210, TX processing circuitry 215, a microphone 220, and RX processing circuitry 225. The STA 111 also may include a speaker 230, a controller/processor 240, an input/output (I/O) interface (IF) 245, a touchscreen 250, a display 255, and a memory 260. The memory 260 may include an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an IF or baseband signal. The IF or baseband signal is sent to the RX processing circuitry 225, which generates a processed baseband signal by filtering, decoding, and/or digitizing the baseband or IF signal. The RX processing circuitry 225 transmits the processed baseband signal to the speaker 230 (such as for voice data) or to the controller/processor 240 for further processing (such as for web browsing data).

The TX processing circuitry 215 receives analog or digital voice data from the microphone 220 or other outgoing baseband data (such as web data, e-mail, or interactive video game data) from the controller/processor 240. The TX processing circuitry 215 encodes, multiplexes, and/or digitizes the outgoing baseband data to generate a processed baseband or IF signal. The RF transceiver 210 receives the outgoing processed baseband or IF signal from the TX processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of downlink signals and the transmission of uplink signals by the RF transceiver 210, the RX processing circuitry 225, and the TX processing circuitry 215 in accordance with well-known principles. The controller/processor 240 can also include processing circuitry configured to provide management of channel sounding procedures in WLANs. In some embodiments, the controller/processor 240 may include at least one microprocessor or microcontroller.

The controller/processor 240 is also capable of executing other processes and programs resident in the memory 260, such as operations for management of channel sounding procedures in WLANs. The controller/processor 240 can move data into or out of the memory 260 as required by an executing process. In some embodiments, the controller/processor 240 is configured to execute a plurality of applications 262, such as applications for channel sounding, including feedback computation based on a received null data packet announcement (NDPA) and null data packet (NDP) and transmitting the beamforming feedback report in response to a trigger frame (TF). The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the main controller/processor 240.

The controller/processor 240 is also coupled to the input 250 (such as touchscreen) and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 3 shows one example of STA 111, various changes may be made to FIG. 3. For example, various components in FIG. 3 could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 3 illustrates the STA 111 configured as a mobile telephone or smartphone, STAs could be configured to operate as other types of mobile or stationary devices.

As shown in FIG. 3, in some embodiment, the STA 111 may be a non-AP MLD that includes multiple STAs 203a-203n. Each STA 203a-203n is affiliated with the non-AP MLD 111 and includes an antenna(s) 205, a RF transceiver 210, TX processing circuitry 215, and RX processing circuitry 225. Each STAs 203a-203n may independently communicate with the controller/processor 240 and other components of the non-AP MLD 111. FIG. 3 shows that each STA 203a-203n has a separate antenna, but each STA 203a-203n can share the antenna 205 without needing separate antennas. Each STA 203a-203n may represent a physical (PHY) layer and a lower media access control (MAC) layer.

The following documents are hereby incorporated by reference in their entirety into the present disclosure as if fully set forth herein: i) IEEE 802.11-2020, “Wireless LAN Medium Access Control (MAC) and Physical Layer (PHY) Specifications,” ii) IEEE 802.11ax-2021, “Wireless LAN Medium Access Control (MAC) and Physical Layer (PHY) Specifications,” and iii) IEEE P802.11be/D2.0, “Wireless LAN Medium Access Control (MAC) and Physical Layer (PHY) Specifications” (hereinafter, collectively “the Standard”).

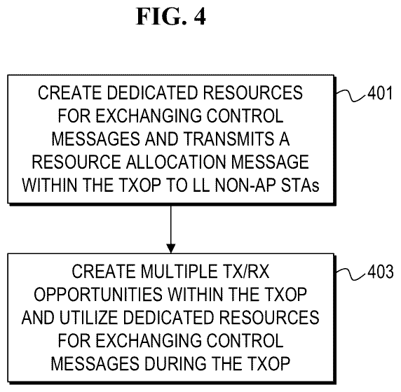

Hereinafter, low latency traffic handling procedures within a transmission opportunity (TXOP) for WLANS in accordance with various embodiments will be described with reference to FIGS. 4 to 13.

FIG. 4 shows low latency traffic handling procedures within a TXOP for WLANS in accordance with an embodiment.

At 401, the AP STA creates one or more dedicated resources for exchanging control messages during a TXOP and transmits a resource allocation message within the TXOP to one or more low latency (LL) non-AP STAs to reserve and allocate the one or more dedicated resources to LL non-AP STAs. In some embodiments, the control messages may include an LL traffic arrival indication message for indicating arrival of LL traffic at an LL station.

In some embodiments, the one or more dedicated resources may be one or more frequency resources for control message exchange during a TXOP. For example, the frequency resource may be a dedicated channel.

In some embodiments, the one or more dedicated resources may be one or more dedicated time resources. For example, the dedicated time recourse may be a time slot that is dedicated at a predetermined point in the TXOP.

In some embodiments, the one or more dedicated resources may be a dedicated resource unit. In some embodiments, as in the 802.11 standard, a group of subcarriers in a data field following a preamble in a PPDU may be referred to as the resource unit.

At 403, the AP STA creates multiple TX/RX opportunities within the TXOP and utilizes one or more dedicated resources for exchanging control messages during the TXOP.

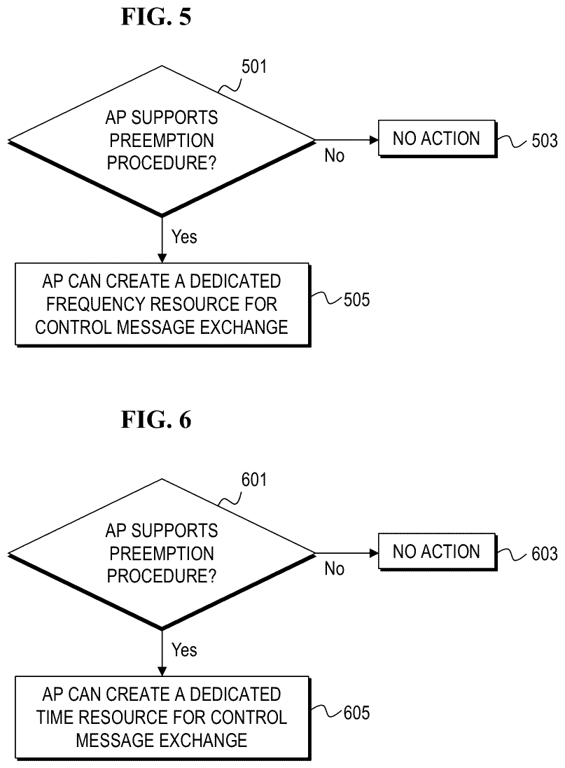

FIG. 5 shows a dedicated frequency resources creation procedure in accordance with an embodiment.

At 501, the AP STA determines whether the AP supports the preemption procedure which makes the LL traffic preempt high throughput traffic. The high throughput traffic may be referred to as non-LL traffic.

At 503, if the AP STA determines that the AP does not support the preemption procedure, the AP STA takes no action.

At 505, if the AP STA determines that the AP supports the preemption procedure, the AP STA, the AP STA creates a dedicated frequency resource for the control message exchange.

FIG. 6 shows a dedicated time resources creation procedure in accordance with an embodiment.

At 601, the AP STA determines whether the AP supports the preemption procedure.

At 603, if the AP STA determines that the AP does not support the preemption procedure, the AP STA takes no action.

At 605, if the AP STA determines that the AP supports the preemption procedure, the AP STA, the AP STA creates a dedicated time resource for the control message exchange.

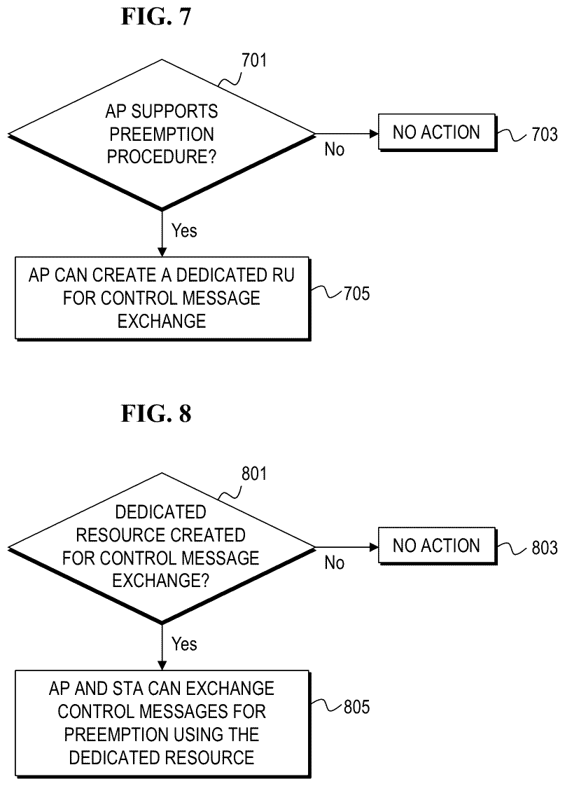

FIG. 7 shows a dedicated resource unit creation procedure in accordance with an embodiment.

At 701, the AP STA determines whether the AP supports the preemption procedure.

At 703, if the AP STA determines that the AP does not support the preemption procedure, the AP STA takes no action.

At 705, if the AP STA determines that the AP supports the preemption procedure, the AP STA, the AP STA creates a dedicated resource unit (RU) for the control message exchange.

FIG. 8 shows a dedicated resource utilization procedure in accordance with an embodiment.

At 801, the AP STA or the non-AP STA determines whether the one or more dedicated resources have been created for control message exchange.

At 803, if the AP STA or the non-AP STA determines that the one or more dedicated resources have not been created for control message exchange, the AP STA or the non-AP STA takes no action.

At 805, if the AP STA or the non-AP STA determines that the one or more dedicated resources have been created for control message exchange, the AP STA or the non-AP STA may exchange control message for preemption using the one or more dedicated resources.

Hereinafter, a procedure for creation of multiple TX/RX opportunities within a TXOP will be described.

In some embodiments, the transmission in a TXOP may be carried out such that the transmitter and receiver go into transmission (TX) and reception (RX) states more than one times within the TXOP. During the RX state, the AP STA may receive traffic arrival indication messages from one or more LL STAs using one or more dedicated resources. The traffic arrival indication message may be in the form of buffer status report (BSR) or in the form of an independent message that may contain indication indicating the transmitting STA has LL traffic. In some embodiments, the longer transmission may be divided into a series of shorter transmissions to create multiple TX and RX states. For example, a long PPDU may be broken down into a series of smaller PPDUs. If the transmission is in the downlink (DL), the AP STA may be in TX state during the transmission of each of these smaller PPDUs. Further, after each PPDU transmits, an acknowledgement (ACK) frame such as the Block ACK frame may be transmitted. Thus, after each TX state, the AP STA may go into an RX state. When the AP STA is in TX state, the AP STA may transmit messages such as buffer status report poll (BSRP) trigger frame on the dedicated resource to check for LL traffic backlog/packet arrival at the LL non-AP STAs. During RX state, the AP STA may receive messages such as BSR on the dedicated resource regarding LL traffic backlog/packet arrival at the LL non-AP STAs.

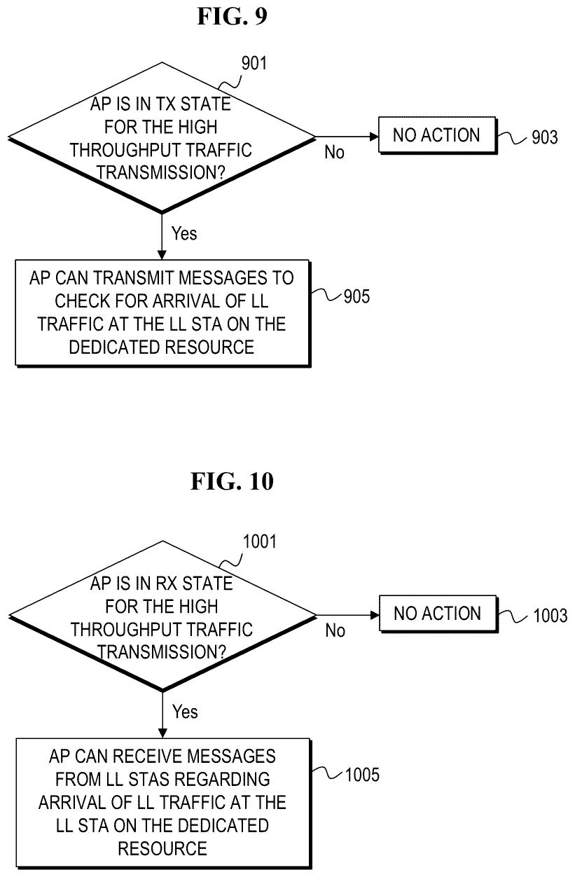

Hereinafter, operations of the AP STA in the TX state and in the RX state will be described with reference to FIG. 9 and FIG. 10.

FIG. 9 shows operations of the AP STA in the transmission state.

At 901, the AP STA determines whether the AP STA is in the transmit (TX) state for high throughput traffic transmission.

At 903, if the AP STA determines that the AP STA is not in the TX state for high throughput traffic transmission, the AP STA takes no action.

At 905, if the AP STA determines that the AP STA is in the TX state for high throughput traffic transmission, the AP STA transmits messages to check for arrival of LL traffic at one or more LL STAs on the one or more dedicated resources.

FIG. 10 shows operations of the AP STA in the reception state.

At 1001, the AP STA determines whether the AP STA is in the reception (RX) state for high throughput traffic transmission. In some embodiments, the RX state may be an idle state.

At 1003, if the AP STA determines that the AP STA is not in the RX state for high throughput traffic transmission, the AP STA takes no action.

At 1005, if the AP STA determines that the AP STA is in the RX state for high throughput traffic transmission, the AP STA receives messages from one or more LL STAs on the one or more dedicated resources. In some embodiments, the message may indicate whether LL traffic has arrived at one or more LL STAs.

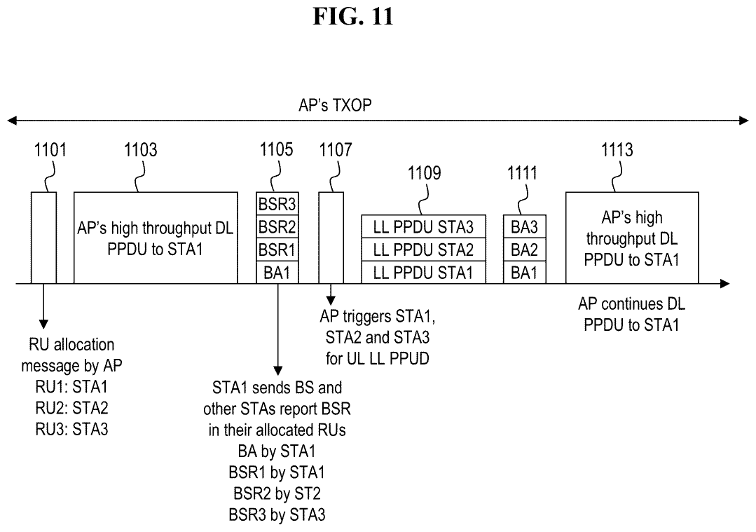

Hereinafter, procedures for handling low latency traffic in accordance with various embodiments will be described with reference to FIGS. 11 to 13.

FIG. 11 shows a procedure for preemption during downlink transmission of high throughput traffic in accordance with an embodiment.

As shown in FIG. 11, the AP station may break down a long DL PPDU including high throughput traffic into smaller DL PPDUs for creating multiple transmit and receive opportunities.

At 1101, the AP station transmits an RU allocation message allocating RUs to non-AP stations. Referring FIG. 11, the allocation message allocates dedicated resource units RU1, RU2, and RU3 to non-AP stations STA1, STA2, and STA3 for sending their BSRs, respectively.

At 1103, the AP STA transmits a first downlink (DL) physical layer (PHY) protocol data unit (PPDU) including high throughput traffic to the non-AP station STA1. In some embodiments, the AP STA may assign a resource unit RU0 for sending a BA frame to the non-AP station STA1.

At 1105, the non-AP station STA1 transmits the BA frame to the AP station in response to the first DL PPDU. When the non-AP station STA1 sends the BA frame, the non-AP stations STA1, STA2 and STA3 may transmit their BSRs on their assigned RUs. Referring to FIG. 11, the non-AP station STA1 transmits the BA frame on the resource unit RU0 and its BSR on the resource unit RU1, the non-AP station STA2 may transmit its BSR on the resource unit RU2, and the non-AP station STA3 may transmit its BSR on the resource unit RU3.

At 1107, the AP STA transmits a trigger frame to trigger LL stations STA1, STA2, and STA3 for sending their LL traffic. In some embodiments, the trigger frame may allocate resource units to the LL stations STA1, STA2, and STA3 for sending their LL traffic.

At 1109, the LL stations STA1, STA2, and STA3 transmit LL PPDUs to the AP station on assigned resource units.

At 1111, in response to the LL PPDUs, the AP station transmits BA frames BA1, BA2, and BA3 to the LL stations STA1, STA2, and STA3, respectively.

At 1113, after the AP station transmits BA frames, the AP station transmits a second DL PPDU including high throughput traffic to the non-AP station STA1 to continue to send the high throughput traffic to the non-AP station STA1.

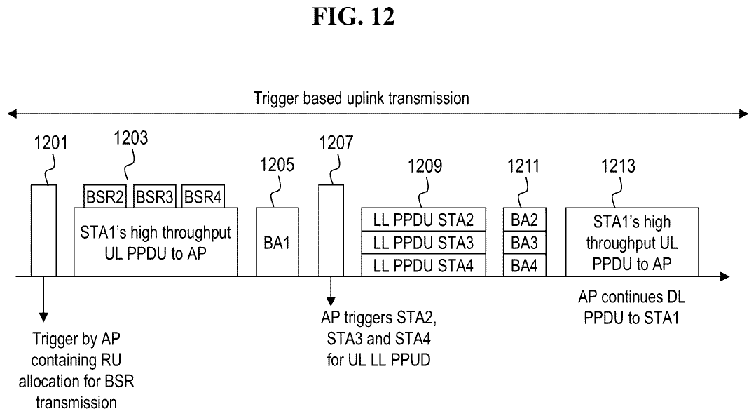

FIG. 12 shows a procedure for preemption during triggered uplink transmission of high throughput traffic in accordance with an embodiment.

At 1201, the AP station transmits a trigger frame which allocates a RU for the non-AP station STA1 to send its high throughput traffic and allocates a dedicated RU to be used for LL stations to send their BSR indicating that LL traffic arrived at non-AP stations.

At 1203, the non-AP station STA1 transmits a first uplink (UL) physical layer (PHY) protocol data unit (PPDU) including high throughput traffic to the AP station. Non-AP stations may transmit their BSRs to the AP station on the dedicated RU during the STA1's transmission of the first UL PPDU. Referring to FIG. 12, the non-AP station STA2 transmits its BSR to the AP station during a first time slot in the dedicated RU, the non-AP station STA3 transmits its BSR to the AP station during a second time slot in the dedicated RU, and the non-AP station STA4 transmits its BSR to the AP station during a third time slot in the dedicated RU. In some embodiments, the first, second, and the third time slots may not be overlapped with each other. In some embodiments, the LL STAs may randomly select the time slot and transmit their BSRs unreliably in these RUs.

At 1205, the AP station transmits the BA frame to the non-AP station STA1 in response to the first UL PPDU.

At 1207, in response to BSRs from the non-AP stations STA2, STA3, and STA4, the AP station transmits a trigger frame to trigger LL stations STA2, STA3, and STA4 for sending their LL traffic. In some embodiments, the trigger frame may allocate resource units to the LL stations STA2, STA3, and STA4 for sending their LL traffic.

At 1209, the LL stations STA2, STA3, and STA4 transmit LL PPDUs to the AP station on assigned resource units.

At 1211, in response to the LL PPDUs, the AP station transmits BA frames BA2, BA3, and BA4 to the LL stations STA2, STA3, and STA4, respectively.

At 1213, after the AP station transmits BA frames, the non-AP station STA1 transmits a second UL PPDU including high throughput traffic to the AP station to continue to send the high throughput traffic to the AP station.

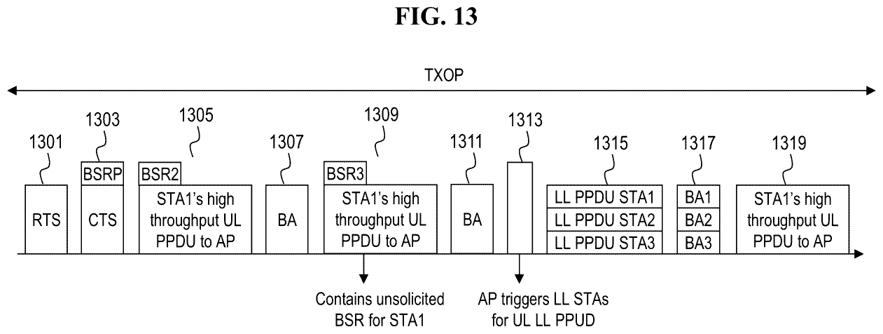

FIG. 13 shows a procedure for handling low latency traffic in accordance with an embodiment.

At 1301, the non-AP station STA1 transmits a request-to-send (RTS).

At 1303, the AP station transmits a clear-to-send (CTS) in response to the RTS. In order to allocate a dedicated control resource unit before the UL transmission of high throughput traffic, during transmission of the CTS, the AP station transmits a BSRP trigger frame which allocates a dedicated control RU to be used for LL stations to send their BSR indicating that LL traffic arrived at non-AP stations.

At 1305, the non-AP station STA1 transmits a first uplink (UL) physical layer (PHY) protocol data unit (PPDU) including high throughput traffic to the AP station. A non-AP station STA2 may transmit its BSR to the AP station on the dedicated control RU during the STA1's transmission of the first UL PPDU.

At 1307, the AP station transmits the BA frame to the non-AP station STA1 in response to the first UL PPDU.

At 1309, the non-AP station STA1 transmits a second (UL) PPDU including high throughput traffic to the AP station to continue to send the high throughput traffic to the AP station. A non-AP station STA3 may transmit its BSR to the AP station on the dedicated control RU during the STA1's transmission of the second UL PPDU. In some embodiments, the second UL PPDU may contain an unsolicited BSR of the non-AP station STA1.

At 1311, the AP station transmits the BA frame to the non-AP station STA1 in response to the second UL PPDU.

At 1313, in response to BSRs from the non-AP stations STA1, STA2, and STA3, before transmission of the next UL PPDU starts, the AP station transmits a trigger frame to trigger LL stations STA1, STA2, and STA3 for sending their LL traffic. In some embodiments, the trigger frame may allocate resource units to the LL stations STA1, STA2, and STA3 for sending their LL traffic.

At 1315, the LL stations STA1, STA2, and STA3 transmit LL PPDUs to the AP station on assigned resource units.

At 1317, in response to the LL PPDUs, the AP station transmits BA frames BA1, BA2, and BA3 to the LL stations STA1, STA2, and STA3, respectively.

At 1319, after the AP station transmits BA frames, the non-AP station STA1 transmits a third UL PPDU including high throughput traffic to the AP station to continue to send the high throughput traffic to the AP station.

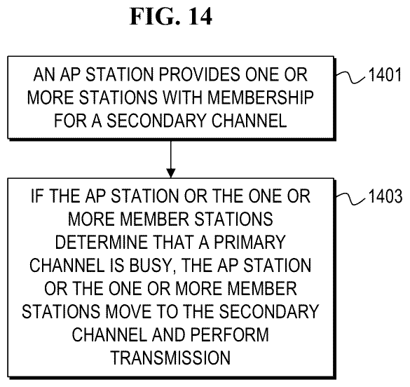

Hereinafter, a frequency management procedure for WLANs in accordance with an embodiment will be described with reference to FIG. 14.

FIG. 14 shows a frequency management procedure for WLANs in accordance with an embodiment.

At 1401, an AP station provides one or more stations with membership for a secondary channel. The one or more stations may include one or more non-AP stations and/or one or more AP stations.

At 1403, if the AP station or the one or more member stations determine that a primary channel is busy, the AP station or the one or more member stations move to the secondary channel and perform transmission.

Hereinafter, management of the membership for the secondary channel will be described.

In some embodiments, membership may be provided for efficient usage of frequency resources. In one example, the AP station may provide membership of a secondary channel for one or more selected stations that have ultra-low latency traffic. Ultra-LL traffic may be transmitted on one or more secondary channels if primary channel is busy. Membership may prevent other non-member STAs from occupying those one or more channels which can be used by member stations. In some embodiments, for efficient multi-AP (MAP) coordination, a plurality of different APs may coordinate the one or more secondary channels to prevent non-member stations from interfering in transmissions by member stations on their secondary channels. In some embodiments, improved coordination for cross technology interference management in cross technologies such as ultra-wideband (UWB), Bluetooth, and unlicensed long-term evolution (LTE) may be achieved by avoiding secondary channels where such interference is dominant. The AP station may avoid providing membership to other non-primary channel(s) to ensure that such interference is avoided.

Hereinafter a negotiation procedure for the membership in accordance with an embodiment will be described.

In some embodiments, a negotiation procedure may be employed to provide one or more stations with membership of secondary channels. The negotiation procedure may involve determination of one or more of the parameters as shown in Table 2 and Table 3.

To negotiate the membership, a station may transmit a negotiation request frame and another station may transmit a negotiation response frame in response to the negotiation request frame.

In some embodiments, the negotiation request frame may include one or more information items as shown in Table 2. Table 2 shows information items that can be present in the negotiation request frame.

TABLE 2

| Information item | Description |
|---|---|
| Channel indication | One or more information items that can describe the channel for which |
| | the membership has been requested. For example, this information |
| | item may include the channel number. |
| Bandwidth | One or more information items that can describe the bandwidth for |
| | which the membership has been requested. For example, this |
| | information item may include the channel bandwidth. |
| Duration | One or more information items that can describe the duration for |
| | which the membership has been requested. For example, this |
| | information item may the number of TBTTs from the current TBTT |
| | for which the duration can last, a duration given in units of TUs, or |
| | both. |
| Transmit | One or more information items that can describe the transmit |
| configuration | configuration for the assigned channel for which membership has been |
| | requested. For example, this information item may include a transmit |
| | power level. |

In some embodiments, the negotiation response frame may include one or more information items as shown in Table 3. Table 3 shows information items that can be present in the negotiation response frame.

TABLE 3

| Information item | Description |
|---|---|
| Channel indication | One or more information items that can describe the channel for which |
| | the membership corresponds to. For example, this information item |
| | may include the channel number. |
| Bandwidth | One or more information items that can describe the bandwidth for |
| | which the membership corresponds to. For example, this information |
| | item may include the channel bandwidth. |
| Duration | One or more information items that can describe the duration for |
| | which the membership has been provided. For example, this |
| | information item may the number of TBTTs from the current TBTT |
| | for which the duration can last, a duration given in units of TUs, or |
| | both. |
| Transmit | One or more information items that can describe the transmit |
| configuration | configuration for the assigned channel for which membership has been |
| | provided. For example, this information item may include a transmit |
| | power level. |

In some embodiments, the assigned membership may be revoked by transmission of a revoke message. The revoke message may be transmitted by a station providing the membership or by a member station.

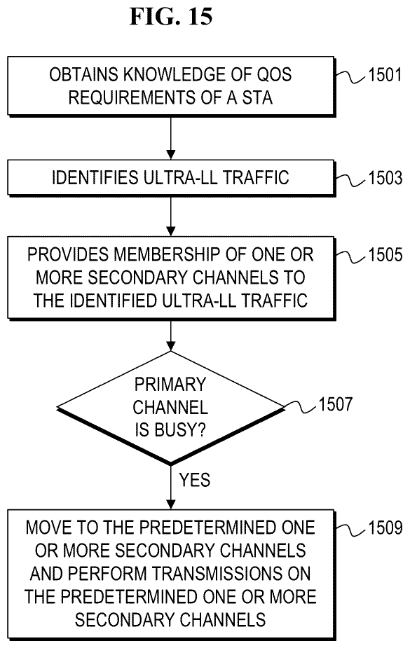

Hereinafter, a procedure for handling ultra-low latency traffic in accordance with an embodiment will be described in accordance with FIG. 15.

FIG. 15 shows a procedure for handling ultra-low latency traffic in accordance with an embodiment.

At 1501, the AP obtains knowledge of quality-of-service (QOS) requirements of a STA.

At 1503, the AP identifies ultra-LL traffic.

At 1505, the AP provides membership of one or more secondary channels to the identified ultra-LL traffic. In some embodiments, the STA may request membership from the AP for the one or more secondary channels.

At 1507, the AP or STA with membership determines that the primary channel is busy due to OBSS interference.

At 1509, if the AP or STA with membership determines that the primary channel is busy, the AP and the STAs with membership move to the predetermined one or more secondary channels and perform transmissions on the predetermined one or more secondary channels. STAs without membership may refrain from switching to the one or more secondary channels and possibly take other actions or enter into a power save (PS) mode.

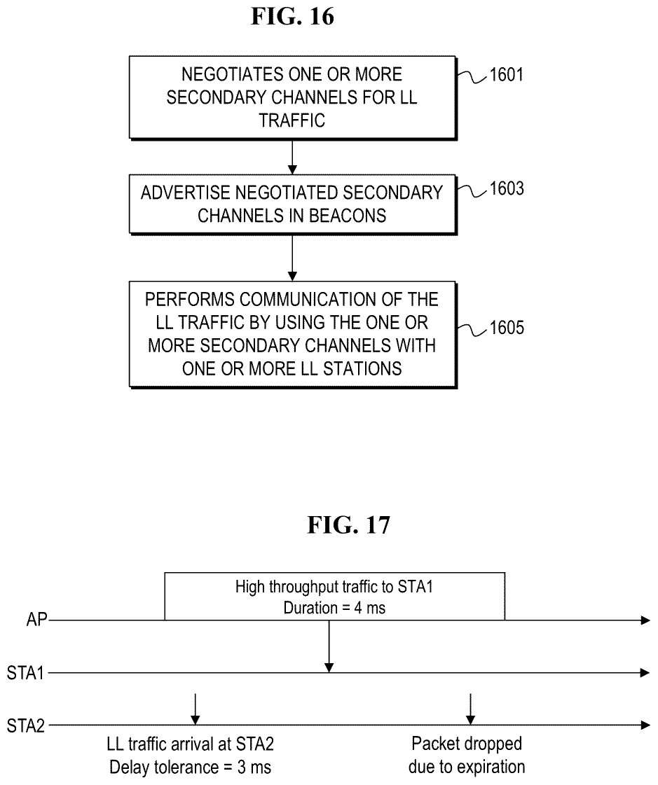

FIG. 16 shows a procedure for multi-AP (MAP) coordination in accordance with an embodiment.

At 1601, an AP negotiates one or more secondary channels for LL traffic with one or more neighboring AP. After the negotiation, the AP and the one or more neighboring AP may become members of the one or more secondary channels. Thus, APs may negotiate the one or more secondary channels amongst each other to avoid any overlap. This may also ensure that the one or more secondary channels are available for LL traffic in each BSS.

At 1603, the AP and the one or more neighboring AP may advertise negotiated secondary channels in their beacons. Other APs without membership of the one or more secondary channels may avoid such channels when possible.

At 1605, the AP with membership performs communication of the LL traffic by using the one or more secondary channels with one or more LL stations. In some embodiments, the AP with membership of one or more secondary channels may transmit LL traffic or control message for the LL traffic to one or more LL stations by using the one or more secondary channels and may receive LL traffic or control message for the LL traffic from one or more LL stations by using the one or more secondary channels.

Hereinafter, a procedure for cross technology interference avoidance in accordance with an embodiment will be described.

In some embodiments, when a cross technology is dominant in one of the non-primary channels, AP may refrain from providing membership to devices for such a channel to avoid interference.

The procedures in this disclosure may be applicable to any type of frequency management setup. For example, the procedures in this disclosure may be applicable to division of frequency channels for better MAP coordination, better coordination between managed and unmanaged networks, etc.

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the disclosure. The word exemplary is used to mean serving as an example or illustration. To the extent that the term “include,” “have,” or the like is used, such term is intended to be inclusive in a manner similar to the term “comprise” as “comprise” is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously or may be performed as a part of one or more other steps, operations, or processes. The accompanying method claims, if any, present elements of the various steps, operations or processes in a sample order, and are not meant to be limited to the specific order or hierarchy presented. These may be performed in serial, linearly, in parallel or in different order. It should be understood that the described instructions, operations, and systems may generally be integrated together in a single software/hardware product or packaged into multiple software/hardware products.

The disclosure is provided to enable any person skilled in the art to practice the various aspects described herein. In some instances, well-known structures and components are shown in block diagram form to avoid obscuring the concepts of the subject technology. The disclosure provides myriad examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using a phrase means for or, in the case of a method claim, the element is recited using the phrase step for.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, the detailed description provides illustrative examples, and the various features are grouped together in various implementations for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed configuration or operation. The following claims are hereby incorporated into the detailed description, with each claim standing on its own as a separately claimed subject matter.

The claims are not intended to be limited to the aspects described herein, but are to be accorded the full scope consistent with the language claims and to encompass all legal equivalents. Notwithstanding, none of the claims are intended to embrace subject matter that fails to satisfy the requirements of the applicable patent law, nor should they be interpreted in such a way.

What is claimed is:

1. An electronic apparatus, comprising:
a memory; and
a processor operably coupled to the memory, the processor configured to cause:
receiving a resource allocation message allocating a dedicated resource for a control message for low latency traffic from an access point,
transmitting an indication message indicating existence of low latency traffic on the dedicated resource to the access point,
receiving a trigger frame eliciting the low latency traffic from the access point, and
transmitting the low latency traffic to the access point in response to the trigger frame.

2. The electronic apparatus of claim 1, wherein the indication message is transmitted on the dedicated resource during uplink transmission performed by a station.

3. The electronic apparatus of claim 1, wherein the indication message is transmitted on the dedicated resource simultaneously when an acknowledgement frame is transmitted by a first station.

4. The electronic apparatus of claim 3, wherein another indication message indicating existence of low latency traffic at a second station is transmitted by the second station on another dedicated resource for the second station simultaneously when the acknowledgement frame is transmitted by the first station.

5. The electronic apparatus of claim 1, wherein the indication message is transmitted in a first duration on the dedicated resource during transmission of an uplink physical layer protocol data unit (PPDU) performed by a first station.

6. The electronic apparatus of claim 5, wherein another indication message indicating existence of low latency traffic at a second station is transmitted by the second station in a second time duration on the dedicated resource during transmission of the uplink PPDU performed by the first station, wherein the second duration is not overlapped with the first duration.

7. The electronic apparatus of claim 5, wherein another indication message indicating existence of low latency traffic at a second station is transmitted by the second station on the dedicated resource during transmission of another uplink PPDU performed by the first station.

8. The electronic apparatus of claim 1, wherein a dedicated resource is used within a transmission opportunity (TXOP) for the control message for low latency traffic,
the indication message is transmitted within the TXOP to the access point,
the trigger frame is received within the TXOP from the access point, and
the low latency traffic is transmitted within the TXOP to the access point.

9. The electronic apparatus of claim 1, wherein the dedicated resource does not overlap with a resource for non-low latency traffic in time and frequency.

10. The electronic apparatus of claim 1, wherein the dedicated resource is a group of subcarriers in a data field following a preamble.

11. An electronic apparatus, comprising:
a memory; and
a processor operably coupled to the memory, the processor configured to cause:
transmitting a resource allocation message allocating a dedicated resource for a control message for low latency traffic to one or more stations,
receiving an indication message indicating existence of low latency traffic on the dedicated resource from a first station,
transmitting a trigger frame eliciting the low latency traffic to the first station, and
receiving the low latency traffic from the first station in response to the trigger frame.

12. The electronic apparatus of claim 11, wherein the indication message is received from the first station on the dedicated resource during uplink transmission performed by a second station.

13. The electronic apparatus of claim 11, wherein the indication message is received from the first station on the dedicated resource simultaneously when an acknowledgement frame is transmitted by a second station.

14. The electronic apparatus of claim 13, wherein another indication message indicating existence of low latency traffic at a third station is received from the third station on another dedicated resource for the third station simultaneously when the acknowledgement frame is transmitted by the second station.

15. The electronic apparatus of claim 11, wherein the indication message is received from the first station in a first duration on the dedicated resource during transmission of an uplink physical layer protocol data unit (PPDU) performed by a second station.

16. The electronic apparatus of claim 15, wherein another indication message indicating existence of low latency traffic at a third station is transmitted by the third station in a second time duration on the dedicated resource during transmission of the uplink PPDU performed by the second station, wherein the second duration is not overlapped with the first duration.

17. The electronic apparatus of claim 15, wherein another indication message indicating existence of low latency traffic at a third station is transmitted by the third station on the dedicated resource during transmission of another uplink PPDU performed by the second station.

18. The electronic apparatus of claim 11, wherein a dedicated resource is used within a transmission opportunity (TXOP) for the control message for low latency traffic,
the indication message is received within the TXOP from the first station,
the trigger frame is transmitted within the TXOP to the first station, and
the low latency traffic is received within the TXOP from the first station.

19. The electronic apparatus of claim 11, wherein the dedicated resource does not overlap with a resource for non-low latency traffic in time and frequency.

20. The electronic apparatus of claim 11, wherein the dedicated resource is a group of subcarriers in a data field following a preamble.
